(19) United States
(12) Patent Application Publication
(10) Pub. No.: US 2007/0103461 A1
(43) Pub. Date: May 10, 2007

(54) VIRTUAL SPACE IMAGE DISPLAY METHOD, APPARATUS, VIRTUAL SPACE IMAGE DISPLAY PROGRAM, AND RECORDING MEDIUM

(75) Inventors: Satoshi Suzuno, Kanagawa (JP); Shizue Okuda, Kanagawa (JP); Natsuo Koda, Kanagawa (JP); Junpei Ito, Tokyo (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Sony Corporation, Shinagawa-ku (JP)

(21) Appl. No.: 11/556,312

(22) Filed: Nov. 3, 2006

(30) Foreign Application Priority Data
Nov. 8, 2005 (JP) P2005-323757

(51) Int. Cl. G06T 15/00

(52) U.S. Cl. 345/419

(57) ABSTRACT

Three-dimensional map data of drawing objects in respective division areas and distant view images in respective directions on map data, which are obtained when viewing is made from insides of the respective division areas, are held in a recording medium, three-dimensional map data of a drawing object for a near view positioned in a sight line direction at a point of interest is retrieved from the three-dimensional map data based on position information of the point of interest and sight line direction information, and is converted into a map image based on a perspective drawing method. A distant view image obtained in the sight line direction is retrieved from the distant view images held in the recording medium based on the position information of the point of interest and the sight line direction information, and the retrieved distant view image is overwritten with the map image for the near view to combine them.

### CROSS REFERENCE TO RELATED APPLICATIONS

The present invention contains subject matter related to Japanese Patent Application JP 2005-323757 filed in the Japanese Patent Office on Nov. 8, 2005, the entire contents of which being incorporated herein by reference.

### BACKGROUND OF THE INVENTION

1. Field of the Invention

The present invention relates to a virtual space image display method, apparatus, a virtual space image display program and a recording medium, that enables drawing of a map image which is close to an actual landscape and is based on a perspective drawing method.

2. Background Art

In related art, when a map image based on a perspective drawing method is drawn, it becomes necessary to perform a processing of extracting a building as a drawing object from map data. As an extraction method of the building as the drawing object, a specific region from a present position or a point of interest is made the drawing object, and data of the building included in the region is extracted. In a map drawing system for drawing the three-dimensional map image based on the perspective drawing method as stated above, since the data amount for buildings to be drawn is limited and the drawing speed is lowered, buildings in a wide region can not be drawn, and buildings in a region neighboring the present position or the point of interest are drawn.

As an apparatus which extracts a drawing object from map data as stated above and creates an image in a sight line direction in a virtual space by a perspective drawing method, there is a virtual space display apparatus including a distant view rendering section in which an object group stored in a distant view object storage section is made an object, a view point is placed at the origin of a coordinate system, a sight line is directed in a direction stored in a sight line direction register, and an image to be obtained in a case where viewing is made in the virtual space is created by the perspective drawing method and is stored in a frame memory, a near view rendering section in which an object group stored in a near view object storage section is made an object, the view point is placed at a position stored in a view point position register, the sight line is directed in the direction stored in the sight line direction register, and an image to be obtained in a case where viewing is made in the virtual space is created by the perspective drawing method and is stored in the frame memory, and a distant view and near view combining section which first starts the distant view rendering section in a case where content of the view point position register or the sight line direction register is updated by an input control section, and next starts the near view rendering section (JP-A-10-83465 (patent document 1)).

### SUMMARY OF THE INVENTION

In the virtual space display apparatus of the related art, the drawing object is extracted from the map data, the image in the sight line direction in the virtual space is created by the perspective drawing method, and the distant view and the near view are combined and displayed. With respect to the distant view image, in the case where the content of the view point position register or the sight line direction register is updated, the object group stored in the distant view object storage section is made the object, the view point is placed at the origin of the coordinate system, the sight line is directed in the direction stored in the sight line direction register, and the distant view image to be obtained in the case where the viewing is made in the virtual space is created by the perspective drawing method and is stored in the frame memory. Besides, also with respect to the near view image, in the case where the content of the view point position register or the sight line direction register is updated, the object group stored in the near view object storage part is made the object, the viewpoint is placed at the position stored in the view point position register, the sight line is directed in the direction stored in the sight line direction register, and the near view image to be obtained in the case where the viewing is made in the virtual space is created by the perspective drawing method and is stored in the frame memory. Then, the distant view image and the near view image are combined and displayed.

As stated above, the object group stored in the distant view object storage section is made the object, and the distant view image is required to be created each time the content of the view point position register or the sight line direction register is updated. Thus, under the situation in which the update of the content of the view point position register or the sight line direction register is repeated in a short time, in order to draw the realistic distant view image, it becomes necessary to perform the processing to create the distant view image by the perspective drawing method each time the content of the view point position register or the sight line direction register is updated. And then, the distant view image, such as a building or a mountain, which should be seen actually on the background of the near view image is displayed.

Thus, there has been a problem that in order to perform the realistic image display in which the distant view image, such as the building or mountain, which should be actually seen on the background of the near view image is displayed, the load in the apparatus including a CPU (Central Processing Unit) for creating the distant view image is increased and the speedup of the processing speed can not be avoided.

In view of the above circumstances, it is desirable to provide a virtual space image display method, apparatus, a virtual space image display program and a recording medium, in which an increase in the load of an apparatus including a CPU is avoided at a time when a distant view image close to an actual landscape, which should be actually seen on the background of a near view image, is displayed, and a realistic map image based on a perspective drawing method can be drawn without enhancing the processing speed.

According to an embodiment of the present invention, there is provided a virtual space image display method in which when viewing is made in an arbitrary direction from a point of interest on map data, a drawing object on the map data positioned in the direction is drawn and displayed on the basis of three-dimensional map data of the drawing object as a map image based on a perspective drawing method, and the virtual space image display method includes the steps of holding three-dimensional map data of drawing objects in respective division areas, which are obtained by dividing the map data into specified areas, in a recording medium for the respective division areas, holding distant view images of drawing objects for a distant view in respective directions on the map data, which are obtained when surroundings are viewed from an inside of the division area, in the recording medium while the distant view images are made to correspond to the division area and the directions, acquiring, by point-of-interest acquisition means, position information of the point of interest and sight line direction information concerning a sight line direction or a traveling direction at the point of interest, retrieving, by neighboring map data retrieval means, three-dimensional map data of a drawing object for a near view positioned in the sight line direction or the traveling direction, including a drawing object in the division area where the point of interest exists, from the three-dimensional map data held in the recording medium on the basis of the acquired position information of the point of interest and the sight line direction information, performing, by real-time rendering means, a rendering processing on the retrieved three-dimensional map data to convert the drawing object for the near view positioned in the sight line direction or the traveling direction into a map image based on the perspective drawing method, retrieving, by distant view data retrieval means, a distant view image obtained when viewing is made in the sight line direction or the traveling direction from the inside of the division area where the point of interest exists, from the distant view images held in the recording medium on the basis of the acquired position information of the point of interest and the sight line direction information, and overwriting, by combining means, the retrieved distant view image with the drawing object for the near view converted into the map image based on the perspective drawing method to combine them, and drawing and displaying them as a map image based on the perspective drawing method in the sight line direction or the traveling direction at the point of interest.

A virtual space image display apparatus according to another embodiment of the invention is a virtual space image display apparatus in which when viewing is made in an arbitrary direction from a point of interest on map data, a drawing object on the map data positioned in the direction is drawn and displayed on the basis of three-dimensional map data of the drawing object as a map image based on a perspective drawing method, and the virtual space image display apparatus includes a recording medium that holds three-dimensional map data of drawing objects in respective division areas which are obtained by dividing the map data into specified areas, and distant view images of drawing objects for a distant view in respective directions on the map data, which are obtained when surroundings are viewed from an inside of the division area, for the respective division areas, point-of-interest acquisition means for acquiring position information of the point of interest and sight line direction information concerning a sight line direction or a traveling direction at the point of interest, neighboring map data retrieval means for retrieving three-dimensional map data of a drawing object for a near view positioned in the sight line direction or the traveling direction, including a drawing object in the division area where the point of interest exists, from the three-dimensional map data held in the recording medium on the basis of the acquired position information of the point of interest and the sight line direction information, real-time rendering means for performing a rendering processing on the retrieved three-dimensional map data to convert the drawing object for the near view positioned in the sight line direction or the traveling direction into a map image based on the perspective drawing method, distant view data retrieval means for retrieving a distant view image obtained when viewing is made in the sight line direction or the traveling direction from the inside of the division area where the point of interest exists, from the distant view images held in the recording medium on the basis of the acquired position information of the point of interest and the sight line direction information, and combining means for overwriting the retrieved distant view image with the drawing object for the near view converted into the map image based on the perspective drawing method to combine them, and for drawing and displaying them as a map image based on the perspective drawing method in the sight line direction or the traveling direction at the point of interest.

A virtual space image display program according to another embodiment of the invention is a virtual space image display program for causing a computer to draw and display, when viewing is made in an arbitrary direction from a point of interest on map data, a drawing object on the map data positioned in the direction on the basis of three-dimensional map data of the drawing object as a map image based on a perspective drawing method, and causes the computer to execute the processes of holding three-dimensional map data of drawing objects in respective division areas, which are obtained by dividing the map data into specified areas, in a recording medium for the respective division areas, holding distant view images of drawing objects for a distant view in respective directions on the map data, which are obtained when surroundings are viewed from an inside of the division area, in the recording medium while the distant view images are made to correspond to the division area and the directions, acquiring, by point-of-interest acquisition means, position information of the point of interest and sight line direction information concerning a sight line direction or a traveling direction at the point of interest, retrieving, by neighboring map data retrieval means, three-dimensional map data of a drawing object for a near view positioned in the sight line direction or the traveling direction, including a drawing object in the division area where the point of interest exists, from the three-dimensional map data held in the recording medium on the basis of the acquired position information of the point of interest and the sight line direction information, performing, by real-time rendering means, a rendering processing on the retrieved three-dimensional map data to convert the drawing object for the near view positioned in the sight line direction or the traveling direction into a map image based on the perspective drawing method, retrieving, by distant view data retrieval means, a distant view image obtained when viewing is made in the sight line direction or the traveling direction from the inside of the division area where the point of interest exists, from the distant view images held in the recording medium on the basis of the acquired position information of the point of interest and the sight line direction information, and overwriting, by combining means, the retrieved distant view image with the drawing object for the near view converted into the map image based on the perspective drawing method to combine them, and drawing and displaying them as a map image based on the perspective drawing method in the sight line direction or the traveling direction at the point of interest.

A recording medium according to another embodiment of the invention is a computer readable recording medium recording a virtual space image display program in which when viewing is made in an arbitrary direction from a point of interest on map data, a drawing object on the map data positioned in the direction is drawn and displayed on the basis of three-dimensional map data of the drawing object as a map image based on a perspective drawing method, and computer-readably records the virtual space image display program for causing a computer to execute the processes of holding three-dimensional map data of drawing objects in respective division areas, which are obtained by dividing the map data into specified areas, in a recording medium for the respective division areas, holding distant view images of drawing objects for a distant view in respective directions on the map data, which are obtained when surroundings are viewed from an inside of the division area, in the recording medium while the distant view images are made to correspond to the division area and the directions, acquiring, by point-of-interest acquisition means, position information of the point of interest and sight line direction information concerning a sight line direction or a traveling direction at the point of interest, retrieving, by neighboring map data retrieval means, three-dimensional map data of a drawing object for a near view positioned in the sight line direction or the traveling direction, including a drawing object in the division area where the point of interest exists, from the three-dimensional map data held in the recording medium on the basis of the acquired position information of the point of interest and the sight line direction information, performing, by real-time rendering means, a rendering processing on the retrieved three-dimensional map data to convert the drawing object for the near view positioned in the sight line direction or the traveling direction into a map image based on the perspective drawing method, retrieving, by distant view data retrieval means, a distant view image obtained when viewing is made in the sight line direction or the traveling direction from the inside of the division area where the point of interest exists, from the distant view images held in the recording medium on the basis of the acquired position information of the point of interest and the sight line direction information, and overwriting, by combining means, the retrieved distant view image with the drawing object for the near view converted into the map image based on the perspective drawing method to combine them, and drawing and displaying them as a map image based on the perspective drawing method in the sight line direction or the traveling direction at the point of interest.

According to the embodiment of the invention, since the distant view image is previously held in the recording medium, it is unnecessary to perform the rendering processing at the time when the distant view image is drawn, it has only to be retrieved and read out from the recording medium, and there is an effect that the virtual space image display method/apparatus, the virtual space image display program and the recording medium can be provided in which an increase in the load of the apparatus including the CPU can be avoided as compared with the case where the rendering processing is performed each time the position of the point of interest, the sight line direction or the traveling direction is changed and the distant view image is drawn.

Besides, since the distant view image is created for each of the division areas so as to have a size corresponding to the distance between the division area and the drawing object for the distant view, there is an effect that the virtual space image display method/apparatus, the virtual space image display program and the recording medium can be provided in which the map image which is based on the perspective drawing method and in which the realistic distant view image is drawn on the background can be drawn without enhancing the processing speed.

### BRIEF DESCRIPTION OF THE DRAWINGS

FIG. 1 is a block diagram showing a hardware structure of a virtual space image display apparatus to which a virtual space image display method of embodiment 1 of the invention is applied.

FIG. 2 is a block diagram showing a structure of software to realize the virtual space image display method of the embodiment 1 of the invention.

FIG. 3 is a flowchart showing the virtual space image display method of the embodiment 1 of the invention.

FIG. 4 is a flowchart showing the virtual space image display method of the embodiment 1 of the invention.

FIG. 5 is a flowchart showing the virtual space image display method of the embodiment 1 of the invention.

FIG. 6 is an explanatory view showing an example of division areas for explaining three-dimensional map data in the embodiment 1 of the invention.

FIG. 7 is an explanatory view of the division areas in the embodiment 1 of the invention and three-dimensional map data stored in an external storage device for the respective division areas.

FIG. 8 is a conceptual view for explaining distant view data in the embodiment 1 of the invention.

FIG. 9 is an explanatory view showing an example of distant view data stored in the external storage device in the embodiment 1 of the invention.

FIG. 10 is an explanatory view showing, in the embodiment 1 of the invention, a distant view image, a map image in the vicinity of a point of interest and based on a perspective drawing method, which is overwritten on the distant view image, and a map image in the vicinity of the point of interest and based on the perspective drawing method, in which the distant view image is drawn on the background.

FIG. 11 is an explanatory view showing a change in the distant view image drawn in the case where the point of interest in the embodiment 1 of the invention is moved in the order of division area E9→E10→E11.

FIG. 12 is a block diagram showing a structure of an in-vehicle navigation apparatus of embodiment 2 of the invention.

FIG. 13 is a block diagram showing a structure of a portable navigation apparatus of embodiment 3 of the invention.

### DETAILED DESCRIPTION OF THE INVENTION

According to an embodiment of the present invention, there is provided a virtual space image display method in which an increase in the load of an apparatus including a CPU is avoided at the time when a distant view image close to an actual landscape, which should be actually seen on the background of a near view image, is displayed, and a realistic map image based on a perspective drawing method can be drawn without enhancing the processing speed, and the virtual space image display method is realized such that three-dimensional map data of drawing objects in respective division areas obtained by dividing the map data into specified ranges are held in a recording medium for the respective division areas, distant view images of drawing objects for a distant view in respective directions on the map data, which are obtained when surroundings are viewed from an inside of the division area, are held in the recording medium while the distant view images are made to correspond to the division area and the directions, point-of-interest acquisition means acquires position information of the point of interest and sight line direction information concerning a sight line direction or a traveling direction at the point of interest, neighboring map data retrieval means retrieves three-dimensional map data of a drawing object for a near view positioned in the sight line direction or the traveling direction, including a drawing object in the division area where the point of interest exists, on the basis of the acquired position information of the point of interest and the sight line direction information from the three-dimensional map data held in the recording medium, real-time rendering means performs a rendering processing on the retrieved three-dimensional map data to convert the drawing object for the near view positioned in the sight line direction or the traveling direction into a map image based on the perspective drawing method, distant view data retrieval means retrieves a distant view image obtained when viewing is made in the sight line direction or the traveling direction from the inside of the division area where the point of interest exists, on the basis of the acquired position information of the point of interest and the sight line direction information from the distant view images held in the recording medium, and combining means overwrites the retrieved distant view image with the drawing object for the near view converted into the map image based on the perspective drawing method to combine them, and draws and displays them as a map image based on the perspective drawing method in the sight line direction or the traveling direction at the point of interest.

Besides, according to another embodiment of the present invention, there is provided a virtual space image display apparatus in which an increase in the load of the apparatus including a CPU is avoided at the time when a distant view image close to an actual landscape, which should be actually seen on the background of a near view image, is displayed, and a realistic map image based on a perspective drawing method can be drawn without enhancing the processing speed, and the virtual space image display apparatus is realized such that three-dimensional map data of drawing objects in respective division areas which are obtained by dividing the map data into specified areas, and distant view images of drawing objects for a distant view in respective directions on the map data, which are obtained when surroundings are viewed from an inside of the division area, are held in a recording medium for the respective division areas, position information of the point of interest and sight line direction information concerning a sight line direction or a traveling direction at the point of interest are acquired by point-of-interest acquisition means, three-dimensional map data of a drawing object for a near view positioned in the sight line direction or the traveling direction, including a drawing object in the division area where the point of interest exists, is retrieved by neighboring map data retrieval means from the three-dimensional map data held in the recording medium on the basis of the acquired position information of the point of interest and the sight line direction information, the retrieved three-dimensional map data is subjected to a rendering processing by real-time rendering means to convert the drawing object for the near view positioned in the sight line direction or the traveling direction into a map image based on the perspective drawing method, a distant view image obtained when viewing is made in the sight line direction or the traveling direction from the inside of the division area where the point of interest exists is retrieved by distant view data retrieval means from the distant view images held in the recording medium on the basis of the acquired position information of the point of interest and the sight line direction information, and the drawing object for the near view converted into the map image based on the perspective drawing method is overwritten on the retrieved distant view image by combining means to combine them, and they are drawn and displayed as a map image based on the perspective drawing method in the sight line direction or the traveling direction at the point of interest.

Besides, according to another embodiment of the present invention, there is provided a virtual space image display program in which an increase in the load of an apparatus including a CPU is avoided at the time when a distant view image close to an actual landscape, which should be actually seen on the background of a near view image, is displayed, and a realistic map image based on a perspective drawing method can be drawn without enhancing the processing speed, and the virtual space image display program is realized by causing a computer to execute the processes of holding three-dimensional map data of drawing objects in respective division areas, which are obtained by dividing the map data into specified areas, in a recording medium for the respective division areas, holding distant view images of drawing objects for a distant view in respective directions on the map data, which are obtained when surroundings are viewed from an inside of the division area, in the recording medium while the distant view images are made to correspond to the division area and the directions, acquiring, by point-of-interest acquisition means, position information of the point of interest and sight line direction information concerning a sight line direction or a traveling direction at the point of interest, retrieving, by neighboring map data retrieval means, three-dimensional map data of a drawing object for a near view positioned in the sight line direction or the traveling direction, including a drawing object in the division area where the point of interest exists, from the three-dimensional map data held in the recording medium on the basis of the acquired position information of the point of interest and the sight line direction information, performing, by real-time rendering means, a rendering processing on the retrieved three-dimensional map data to convert the drawing object for the near view positioned in the sight line direction or the traveling direction into a map image based on the perspective drawing method, retrieving, by distant view data retrieval means, a distant view image obtained when viewing is made in the sight line direction or the traveling direction from the inside of the division area where the point of interest exists, from the distant view images held in the recording medium on the basis of the acquired position information of the point of interest and the sight line direction information, and overwriting, by combining means, the retrieved distant view image with the drawing object for the near view converted into the map image based on the perspective drawing method to combine them, and drawing and displaying them as a map image based on the perspective drawing method in the sight line direction or the traveling direction at the point of interest.

Besides, according to another embodiment of the present invention, there is provided a recording medium in which an increase in the load of an apparatus including a CPU is avoided at the time when a distant view image close to an actual landscape, which should be actually seen on the background of a near view image, is displayed, and a realistic map image based on a perspective drawing method can be drawn without enhancing the processing speed, and the recording medium is realized by computer-readably recording a virtual space image display program for causing a computer to execute the processes of holding three-dimensional map data of drawing objects in respective division areas, which are obtained by dividing the map data into specified areas, in a recording medium for the respective division areas, holding distant view images of drawing objects for a distant view in respective directions on the map data, which are obtained when surroundings are viewed from an inside of the division area, in the recording medium while the distant view images are made to correspond to the division area and the directions, acquiring, by point-of-interest acquisition means, position information of the point of interest and sight line direction information concerning a sight line direction or a traveling direction at the point of interest, retrieving, by neighboring map data retrieval means, three-dimensional map data of a drawing object for a near view positioned in the sight line direction or the traveling direction, including a drawing object in the division area where the point of interest exists, from the three-dimensional map data held in the recording medium on the basis of the acquired position information of the point of interest and the sight line direction information, performing, by real-time rendering means, a rendering processing on the retrieved three-dimensional map data to convert the drawing object for the near view positioned in the sight line direction or the traveling direction into a map image based on the perspective drawing method, retrieving, by distant view data retrieval means, a distant view image obtained when viewing is made in the sight line direction or the traveling direction from the inside of the division area where the point of interest exists, from the distant view images held in the recording medium on the basis of the acquired position information of the point of interest and the sight line direction information, and overwriting, by combining means, the retrieved distant view image with the drawing object for the near view converted into the map image based on the perspective drawing method to combine them, and drawing and displaying them as a map image based on the perspective drawing method in the sight line direction or the traveling direction at the point of interest.

### Embodiment 1

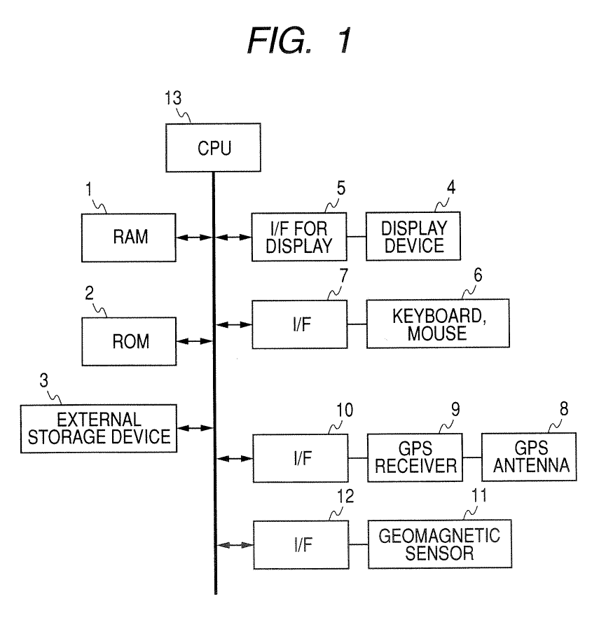

FIG. 1 is a block diagram showing a hardware structure of a virtual space image display apparatus to which a virtual space image display method of embodiment 1 is applied. This virtual space image display apparatus includes a RAM (Random Access Memory) 1, a ROM (Read Only Memory) 2, an external storage device (recording medium) 3 which previously stores three-dimensional map data including information indicating positions and forms of constructions, such as roads and buildings, of map data divided into specified division areas, and distant view data indicating distant view images for the respective division areas and having been previously subjected to a rendering processing, a display device 4, a display interface 5 for transmitting/receiving various signals to display map images based on a perspective drawing method to/from the display device 4, an input device 6 including a keyboard, a mouse or an operation pad for variously operating the virtual space image display apparatus, an interface 7 for inputting, as an electric signal, the operation of a user through the input device 6 to the virtual space image display apparatus, a GPS receiver 9 provided with a GPS (Global Positioning System) antenna 8, an interface 10 through which a CPU 13 transmits/receives various signals to/from the GPS receiver 9, a geomagnetic sensor 11 that detects terrestrial magnetism and outputs an orientation signal with a specified resolution for determining the orientation of a sight line direction or a traveling direction, and an interface 12 through which the CPU 13 transmits/receives various signals including the orientation signal outputted from the geomagnetic sensor 11 to/from the geomagnetic sensor 11.

The external storage device 3 may be a storage device which can read/write data from/to various disks including a hard disk and an optical disk or a recording medium such as a semiconductor memory, or may be a server system which can configure a database.

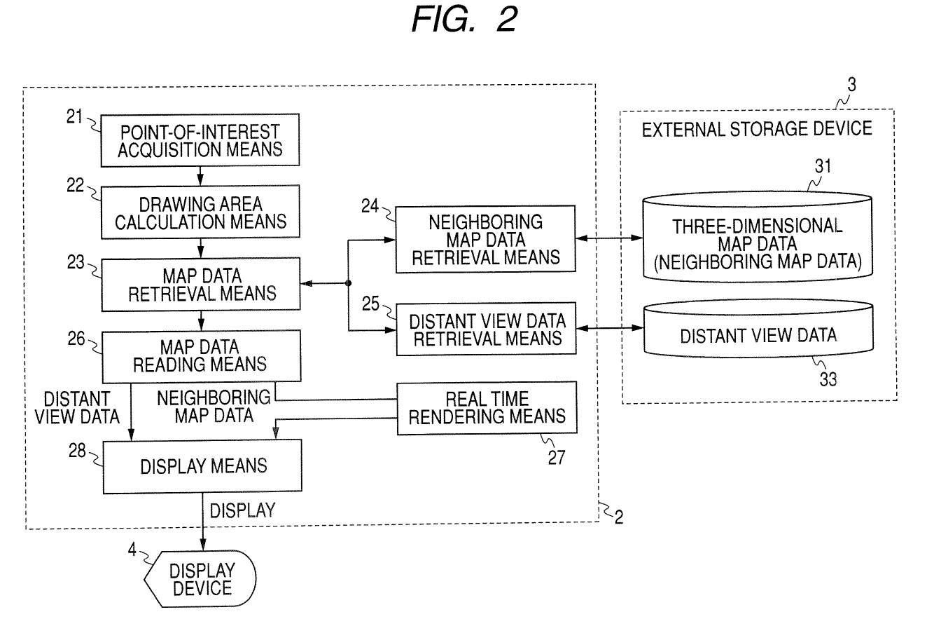

FIG. 2 is a block diagram showing a structure of software for realizing the virtual space image display method.

The structure of the software includes point-of-interest acquisition means 21, drawing region calculation means 22, map data retrieval means 23, neighboring map data retrieval means 24, distant view data retrieval means 25, three-dimensional map data 31, distant view data 33, map data reading means (combining means) 26, real-time rendering means 27, and display means (combining means) 28.

The point-of-interest acquisition means 21, the drawing region calculation means 22, the map data retrieval means 23, the neighboring map data retrieval means 24, the distant view data retrieval means 25, the map data reading means 26, the real-time rendering means 27, and the display means 28 are stored as programs in the ROM 2.

The three-dimensional map data 31 is stored, as three-dimensional data including information indicating positions and forms of constructions, such as roads and buildings, for respective specified division areas defined by longitude and latitude information on map data, in the external storage device 3 for the respective specified division areas.

With respect to the distant view data 33, in each of the specified division areas, an image seen as a distant view in the case where viewing is made from the inside of the division area to the east, west, south and north is previously subjected to a rendering processing to form a distant view image, and the distant view data is stored as the distant view image in the external device 3. The distant view image includes artificial constructions such as buildings, and natural objects such as mountains, rivers and trees.

Incidentally, in this embodiment 1, although the shape of the division area is the rectangle obtained by dividing the map mesh of the Geographical Survey Institute, no limitation is made to the map mesh of the Geographical Survey Institute, and a map by another publisher and having another form may be used. Besides, it is not necessary to limit the shape of the division area to the rectangle, and another shape such as a hexagon or a circle may be adopted.

The point-of-interest acquisition means 21 realizes a function to acquire position information of a point of interest and sight line direction information concerning a sight line direction or a traveling direction from the latitude and longitude information detected based on the GPS signal received by the GPS receiver 9 from the GPS satellite, and to determine the division area where the point of interest is included.

Incidentally, the point-of-interest acquisition means 21 can also acquire the position information of the point of interest or the present position by using a portable telephone including a PHS (Personal Handy-phone System).

Besides, in the case where the point of interest, and the sight line direction or the traveling direction at the point of interest are directly inputted and set from the input device including the keyboard, the mouse or the operation pad by the operation of the user on the map data displayed on the display device 4, the position information of the point of interest and the sight line direction information are acquired from the latitude and longitude information of the inputted and set point of interest, and the sight line direction or the traveling direction at the point of interest, and the division area where the point of interest is included can be determined.

Besides, in the case where the latitude and longitude information of the point of interest, and the sight line direction or the traveling direction at the point of interest are directly inputted and set from the input device including the keyboard, the mouse or the operation pad by the operation of the user, the position information of the point of interest is acquired from the inputted and set latitude and longitude information, the sight line direction information is acquired from the inputted and set sight line direction or traveling direction, and the division area where the point of interest is included can be determined.

The drawing region calculation means 22 has a function to calculate, as a drawing region near a point of interest, a specific region on the map data in the sight line direction or the traveling direction from the point of interest acquired by the point-of-interest acquisition means 21.

The drawing region near the point of interest is calculated as a triangular or fan-shaped region defined by, for example, the position of the point of interest, the sight line direction information of the sight line direction or the traveling direction at the point of interest, a visual field range around the direction, and a drawing distance from the point of interest.

The three-dimensional data in the drawing region near the point of interest is extracted from the three-dimensional map data 31, and is drawn as the map image near the point of interest and based on the perspective drawing method. The map image based on the perspective drawing method includes artificial constructions such as roads and buildings, and natural objects such as roadside trees and rivers.

The drawing region calculation means 22 has a function to calculate a drawing region of a distant view image as the background of the map image near the point of interest drawn based on the division area where the point of interest acquired by the point-of-interest acquisition means 21 is included and the calculated drawing region near the point of interest. The calculation of the drawing region of the distant view image is performed by, for example, calculating the range of the distant view image of the division area which is included in the visual field range of the drawing region near the point of interest and in which the point of interest exists.

The map data retrieval means 23 has a function to retrieve three-dimensional data in the drawing region near the point of interest calculated by the drawing region calculation means 22 from the three-dimensional map data 31, and to retrieve distant view data corresponding to the division area, where the point of interest is included, from the distant view data 33.

The neighboring map data retrieval means 24 retrieves the three-dimensional data included in the drawing region near the point of interest calculated by the drawing region calculation means 22 from the three-dimensional map data 31 stored in the external storage device 3.

The distant view data retrieval means 25 retrieves the distant view data for drawing the distant view image from the distant view data 33 stored in the external storage device 3 based on the drawing region of the distant view image calculated by the drawing region calculation means 22.

The distant view image developed with the distant view data includes a mountain or a construction seen, as the distant view from the point of interest, in the visual field range defining the drawing region near the point of interest calculated by the drawing region calculation means 22.

The map data reading means 26 reads the three-dimensional data retrieved by the neighboring map data retrieval means 24 from the external storage device 3. Besides, the map data reading means 26 reads the distant view data retrieved by the distant view data retrieval means 25 from the external storage device 3.

The real-time rendering means 27 performs a real-time rendering processing on the three-dimensional data read out from the external storage device 3 by the map data reading means 26, and converts a drawing object in the drawing region near the point of interest into the map image based on the perspective drawing method.

The display means 28 writes the distant view image developed with the distant view data read out from the external storage device 3 by the map data reading means 26 into a frame memory. Next, the distant view image is overwritten with the drawing object in the drawing region near the point of interest, which is converted by the real-time rendering means 27 into the map image based on the perspective drawing method.

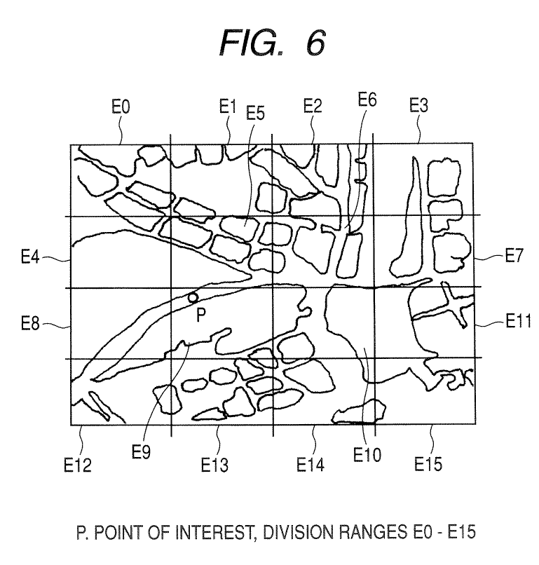

FIG. 6 is an explanatory view showing an example of division areas for explaining the three-dimensional map data.

In the example of FIG. 6, the map data is divided into rectangular division areas E0, E1, E2, E3, E4, E5, E6, E7, E8, E9, E10, E11, E12, E13, E14 and E15 specified by the latitude and longitude. The three-dimensional map data 31 represents drawing objects, such as constructions, included in the respective division areas by stereoscopic three-dimensional data with coordinates of respective apexes, and represents the positions where those constructions exist by latitudes and longitudes, and they are respectively stored as files in the external storage device 3.

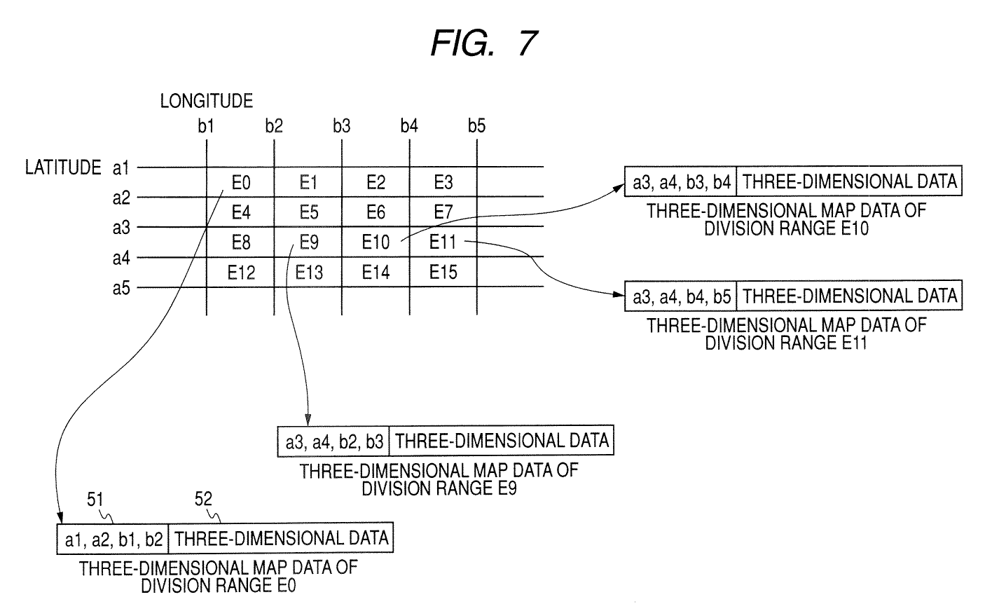

FIG. 7 is an explanatory view of the division areas and the three-dimensional map data stored in the external storage device 3 for the respective division areas. In the figure, reference numeral 51 denotes the division area E0 specified by latitudes a1 and a2 and longitudes b1 and b2, and reference numeral 52 denotes three-dimensional data of the division area E0.

The distant view data 33 represents distant view images, and when a drawing object in a drawing region is drawn as a map image based on the perspective drawing method, the distant view image is drawn on the background of the map image and has been previously subjected to the rendering processing. The distant view data 33 is paired with each of the division areas shown in FIG. 6 or FIG. 7. The distant view images seen from the inside of the paired division area in the respective directions of the east, west, south and north of the circumference of 360 degrees are formed into files as the distant view data 33 and are stored in the external storage device 3.

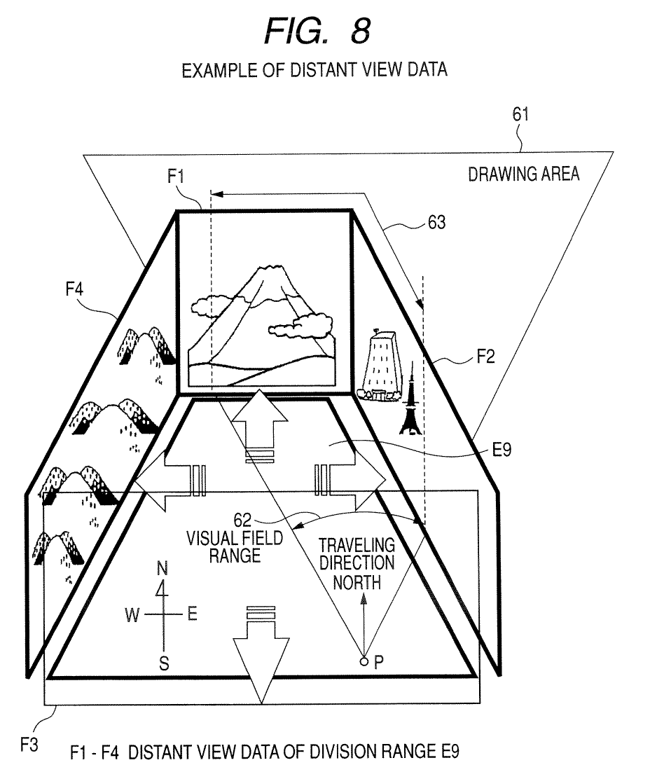

FIG. 8 is a conceptual view for explaining the distant view data. In the figure, F1 denotes distant view data seen in the north direction from, for example, the center position of the division area E9, F2 denotes distant view data seen in the east direction from the center position of the division area E9, F3 denotes distant view data seen in the south direction from the center position of the division area E9, and F4 denotes distant view data seen in the west direction from the center position of the division area E9.

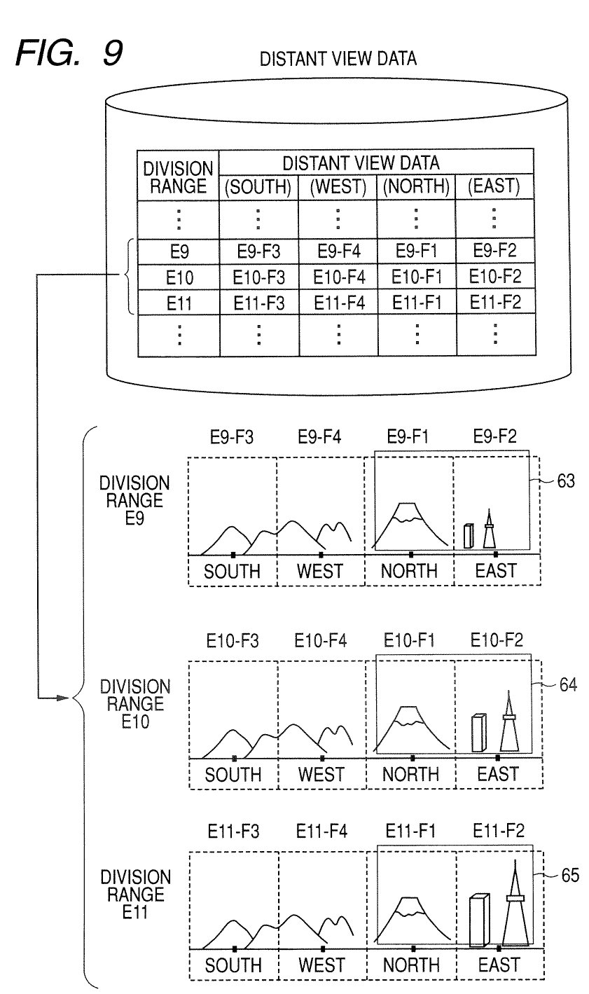

FIG. 9 is an explanatory view showing an example of the distant view data 33 stored in the external storage device 3. In the example shown in FIG. 9, E9-F1 denotes distant view data seen in the north direction from the inside of the division area E9, E9-F2 denotes distant view data seen in the east direction from the inside of the division area E9, E9-F3 denotes distant view data seen in the south direction from the inside of the division area E9, and E9-F4 denotes distant view data seen in the west direction from the inside of the division area E9. Besides, E10-F1 denotes distant view data seen in the north direction from the inside of the division area E10, E10-F2 denotes distant view data seen in the east direction from the inside of the division area E10, E10-F3 denotes distant view data seen in the south direction from the inside of the division area E10, and E10-F4 denotes distant view data seen in the west direction from the inside of the division area E10. Besides, E11-F1 denotes distant view data seen in the north direction from the inside of the division area E11, E11-F2 denotes distant view data seen in the east direction from the inside of the division area E11, E11-F3 denotes distant view data seen in the south direction from the inside of the division area E11, and E11-F4 denotes distant view data seen in the west direction from the inside of the division area E11. The distant view image seen in the east, west, south or north from the inside of each of the division areas is created for each division area according to the distance between the position of the division area and the position of the object seen as the distant view and in accordance with a change in a distant view actually seen when the point of interest passes through the division area and is moved.

Next, the operation will be described.

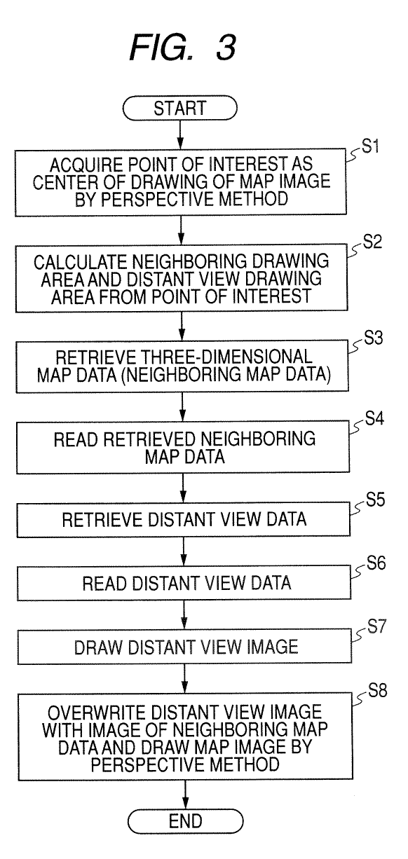

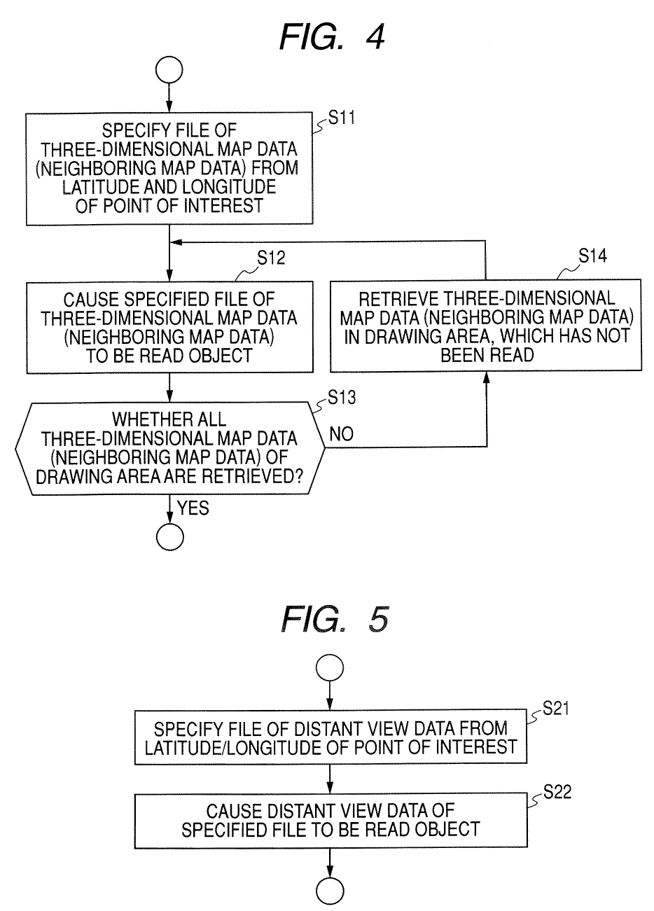

FIG. 3, FIG. 4 and FIG. 5 are flowcharts showing the virtual space image display method of the embodiment 1. Hereinafter, the operation will be described with reference to the flowcharts shown in FIG. 3, FIG. 4 and FIG. 5.

In the flowchart shown in FIG. 3, first, the point of interest acquisition means 21 acquires the point of interest (step S). The acquisition of the point of interest is realized in such a manner that the CPU 13 executes the point-of-interest acquisition means 21. That is, in the case where the present position can be determined from the latitude and longitude information detected based on the GPS signal received from the GPS satellite, the point-of-interest acquisition means 21 acquires the point of interest and the sight line direction information concerning the sight line direction or traveling direction from the latitude and longitude information using the GPS satellite, and further determines the division area on the map data where the point of interest is included.

Besides, in the case where the point of interest and the sight line direction or traveling direction at the point of interest are directly inputted and set on the map data displayed on the display device 4 from the input device including the keyboard, the mouse, or the operation pad by the cursor movement based on the user's operation, the point of interest and the sight line direction information are acquired from the latitude and longitude information of the inputted and set point, and the inputted and set sight line direction or traveling direction, and further, the specified division area where the point of interest is included is determined.

Besides, in the case where the latitude and longitude information of the point of interest, the sight line direction or traveling direction at the point of interest are directly inputted and set from the input device including the keyboard, the mouse or the operation pad by the user's operation, the position information of the point of interest on the map data is acquired from the inputted and set latitude and longitude information, and the sight line direction information is acquired from the inputted and set sight line direction or traveling direction, and further, the specified division area where the point of interest is included is determined.

Next, the drawing region calculation means 22 calculates the drawing region near the point of interest in the sight line direction or the traveling direction from the point of interest. The calculation of the drawing region is realized in such a manner that the CPU 13 executes the drawing region calculation means 22.

That is, the drawing region near the point of interest is calculated as the triangular or fan-shaped area determined by, for example, the latitude and longitude of the point of interest, the sight line direction information as the sight line direction or the traveling direction at the point of interest, the visual field range around the direction, and the specified distance from the point of interest.

The drawing region calculation means 22 calculates the drawing region of the distant view image as, for example, the drawing region of the distant view image in the sight line direction or traveling direction within the division area where the point of interest exists, or as the range of the distant view image of the division area where the point of interest exists, which is included in the visual field range of the drawing region near the point of interest.

Here, an example of the drawing region of the distant view image calculated by the drawing region calculation means 22 will be described. In FIG. 8, the point of interest, that is, the present position is made point P. The sight line direction or traveling direction is the north direction. Reference numeral 61 denotes the drawing region near the point of interest in the sight line direction or traveling direction calculated by the drawing region calculation means 22 with respect to the present position of the point of interest P acquired by the point-of-interest acquisition means 21 based on the latitude and longitude information.

Reference numeral 62 denotes the visual field range of the drawing region 61 near the point of interest at the point of interest P. Reference numeral 63 denotes the range of the distant view image of the division area E9 where the point of interest P exists, which is included in the visual field range 62 of the drawing region near the point of interest. The drawing region calculation means 22 calculates the range 63 of the distant view image. FIG. 9 shows the range 63 of the distant view data calculated by the drawing region calculation means 22 in the case where the point of interest P exists in the division area E9.

Next, the neighboring map data retrieval means 24 retrieves three-dimensional map data (step S3). The retrieval of the three-dimensional map data is realized in such a manner that the CPU 13 executes the neighboring map data retrieval means 24. The neighboring map data retrieval means 24 retrieves the three-dimensional data of constructions and the like included in the drawing region near the point of interest calculated by the drawing region calculation means 22 from the three-dimensional map data 31.

FIG. 4 is the flowchart showing the details of the retrieval processing of the three-dimensional map data on the step S3 in FIG. 3. The retrieval processing of the three-dimensional map data on the step S3 in FIG. 3 will be described with reference to FIG. 4.

The neighboring map data retrieval means 24 specifies a file of three-dimensional data of constructions and the like included in the division area where the point of interest exists from the latitude and longitude information of the point of interest (step S11). The neighboring map data retrieval means 24 causes the specified file of the three-dimensional data to be the reading object (step S12).

Further, the neighboring map data retrieval means 24 judges whether in addition to the specified file, all files of the three-dimensional data included in the drawing region near the point of interest calculated by the drawing region calculation means 22 are retrieved (step S13). In the state where all the files of the three-dimensional data included in this drawing region have not been retrieved, the file of the three-dimensional data in the drawing region, which has not been read, is retrieved. In this case, since there is a case where the drawing region near the point of interest calculated by the drawing region calculation means 22 extends over plural division areas, the neighboring map data retrieval means 24 retrieves the file of the three-dimensional data in the drawing region also with respect to another division area to which the drawing region near the point of interest extends (step S14). With respect to all division areas to which the drawing region near the point of interest extends, the files of the three-dimensional data in the drawing region are retrieved.

Return is made to the flowchart shown in FIG. 3, and next, the map data reading means 26 reads the three-dimensional data of the drawing region near the point of interest retrieved by the neighboring map data retrieval means 24 with respect to the three-dimensional map data 31 (step S4).

Next, the distant view data retrieval means 25 retrieves the distant view data concerning the drawing region of the distant view image calculated by the drawing region calculation means 22 (step S5). The retrieval of the distant view data is realized in such a manner that the CPU 13 executes the distant view data retrieval means 25.

FIG. 5 is the flowchart showing the retrieval processing of the distant view data on the step S5 in FIG. 3. In the retrieval processing of the distant view data, the distant view data retrieval means 25 specifies, from the file of the distant view data in the division area where the point of interest determined by the point-of-interest acquisition means 21 exists, the file of the distant view data 33 in the range of the drawing region calculated by the drawing region calculation means 22 with respect to the distant view image (step S21). Next, the distant view data of the specified file is made the read object (step S22).

Return is made to the flowchart shown in FIG. 3, and next, the map data reading means 26 reads the range 63 of the distant view data from the file of the distant view data retrieved and specified by the distant view data retrieval means 25 with respect to the distant view data 33 (step S6).

The display means 28 writes the distant view data read by the map data reading means 26 into the frame memory, and performs the drawing of the distant view image (step S7).

In this case, since the distant view data is the distant view image previously subjected to the rendering processing, even in the case where the distant view image is changed each time the position of the point of interest, or the sight line direction or traveling direction from the point of interest is updated, the distant view data is not required to be subjected to the rendering processing, and has only to be retrieved and read from the external storage device 3. Thus, as compared with the case where the rendering processing is performed each time the position of the point of interest, or the sight line direction or traveling direction from the point of interest is updated, an increase in the load of the apparatus including the CPU can be avoided, and the realistic distant view image can be drawn without enhancing the processing speed.

On the other hand, the real-time rendering means 27 applies the real-time rendering processing to the three-dimensional data read by the map data reading means 26. The real-time rendering means 27 converts constructions and the like included in the drawing region near the point of interest into the map image based on the perspective drawing method. The display means 28 overwrites the map image of the constructions and the like near the point of interest and based on the perspective drawing method to the frame memory in which the distant view image based on the distant view data is written, outputs the map image of the constructions and the like near the point of interest and based on the perspective drawing method, in which the distant view image is drawn on the background, to the display device 4, and displays it (step S8).

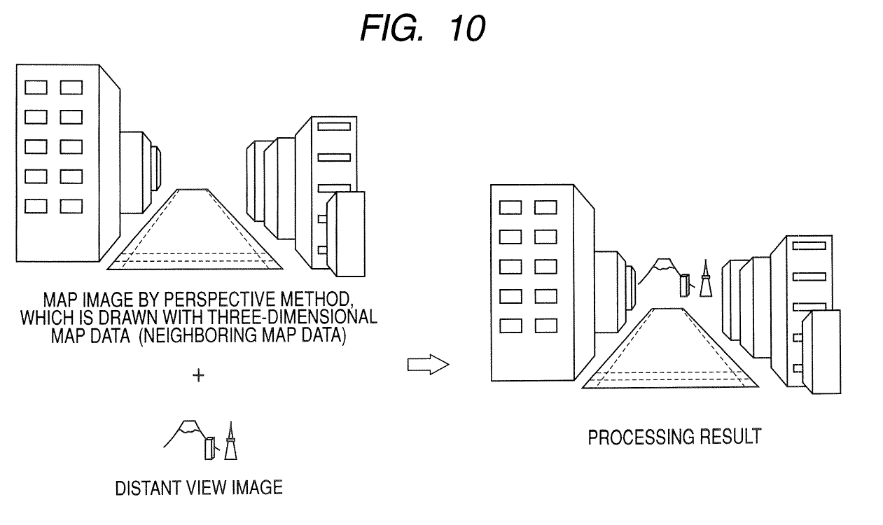

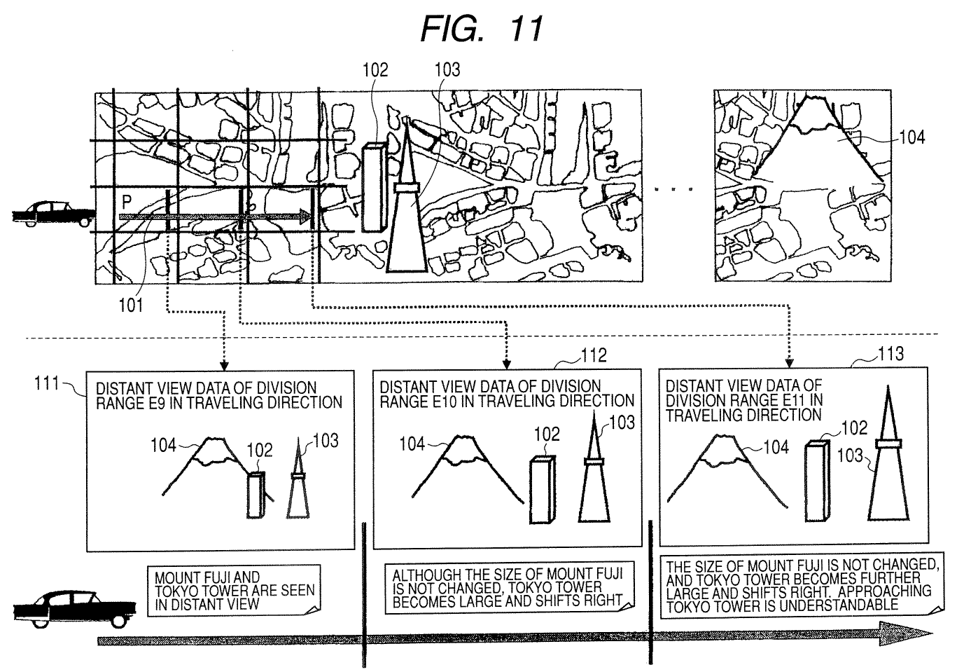

FIG. 10 is an explanatory view showing the distant view image, the map image near the point of interest and based on the perspective drawing method, which is overwritten on the distant view image, and the map image near the point of interest and based on the perspective drawing method, in which the distant view image is drawn on the background.

FIG. 11 is an explanatory view showing a change in the distant view image drawn in the case where the point of interest P, that is, the present position moves in the order of the division areas E9→E10→E11. In FIG. 11, reference numeral 101 denotes the traveling direction, for example, the north direction. In the traveling direction from the present position of the point of interest P, a high building 102 and Tokyo Tower 103 are seen as the distant view, and Mount Fuji 104 is seen farther away.

In the case where the present position of the point of interest P exists in the division area E9, the range of the distant view data calculated by the drawing region calculation means 22 is the range indicated by reference numeral 63 shown in FIG. 9, and is drawn as the distant view image indicated by reference numeral 111 of FIG. 11. Incidentally, the distant view image 111 is overwritten with, as the map image based on the perspective drawing method, constructions and the like of the drawing region near the point of interest calculated in the traveling direction from the present position of the point of interest P by the drawing region calculation means 22. The drawing region near the point of interest calculated by the drawing region calculation means 22 is updated in accordance with the movement of the point of interest, and the map image overwritten on the distant view image 111 and based on the perspective drawing method is also updated in accordance with the movement of the point of interest.

In the case where the present position of the point of interest P is moved into the division area E10, the range of the distant view data calculated by the drawing region calculation means 22 is the range denoted by reference numeral 64 shown in FIG. 9, and is drawn as the distant view image denoted by reference numeral 112 of FIG. 11 by the display means 28. Incidentally, the distant view image 112 is overwritten with, as the map image based on the perspective drawing method, the constructions and the like in the drawing region near the point of interest calculated in the traveling direction from the present position of the point of interest P by the drawing region calculation means 22. In the case where the distant view image 112 is compared with the distant view image 111, the high building 102 and the Tokyo Tower 103 drawn in the distant view image 112 are drawn to be rather large and to shift in the right direction. On the other hand, the Mount Fuji 104 is drawn in the state where the position and size are not changed.

This is because as compared with the distance from the present position of the point of interest P to the high building 102 or the Tokyo Tower 103, the distance from the point of interest P to the Mount Fuji 104 is remarkably large, and the movement distance (distance between one division area and the next division area) of the point of interest P is almost neglected with respect to the distance from the point of interest P to the Mount Fuji 104, whereas it can not be neglected with respect to the distance from the point of interest P to the high building 102 or the Tokyo Tower 103.

As stated above, the distant view image is created, for each division area, to have the drawing position and the size according to the distance between the position of the division area and the distant view image drawing object, such as the high building 102, the Tokyo Tower 103, or the Mount Fuji 104 and in accordance with the change in the distant view actually seen when the point of interest is moved.

Further, in the case where the present position of the point of interest P is moved into the division area E11, the range of the distant view data calculated by the drawing region calculation means 22 is the range denoted by reference numeral 65 shown in FIG. 9, and is drawn as the distant view image denoted by reference numeral 113 of FIG. 11 by the display means 28.

The distant view image 113 is overwritten with, as the map image based on the perspective drawing method, the constructions and the like in the drawing region near the point of interest calculated by the drawing region calculation means 22 in the traveling direction from the present position of the point of interest P. In the case where the distant view image 113 is compared with the distant view image 111, the high building 102 and the Tokyo Tower 103 drawn in the distant view image 113 are sufficiently large, and are drawn to further shift in the right direction, and it can be actually felt also from the distant view image that the present position of the point of interest P further approaches the position where the high building 102 and the Tokyo Tower 103 can be visually seen in the right and forward direction. On the other hand, the Mount Fuji 104 is drawn in the state where the position and size are not changed.

As stated above, the distant view data for each of the division areas is previously made so that when the point of interest P is moved, the realistic distant view image can be drawn. That is, the distant view data of each division area is subjected to the operation in the distant view image structure such that in view of the distance from the object, such as the high building 102, the Tokyo Tower 103, or the Mount Fuji 104, adopted as the distant view image to the division area, its size and drawing position are changed for each division area, or they are not changed at all.

In the above description, although the point-of-interest acquisition means 21, the drawing region calculation means 22, the map data retrieval means 23, the neighboring map data retrieval means 24, the distant view data retrieval means 25, the map data reading means 26, the real-time rendering means 27, and the display means 28 are stored as programs in the ROM 2, they may have such form that as programs executable by a computer, they are written in a recording medium, such as a magnetic disk, an optical disk, or a semiconductor memory, and the CPU of the virtual space image display apparatus reads the programs stored in the recording medium and executes them.

Besides, although the description has been made on the assumption that the three-dimensional map data 31 and the distant view data 33 are stored in the external storage device 3, there may be provided a function to download the three-dimensional map data 31 and the distant view data 33 from a database configured in an external server system to the virtual space image display apparatus by communication means and by wireless. In this case, before the point of interest, that is, the present position enters the inside of the division area, the distant view data 33 of the division area is downloaded from the external database to the virtual space image display apparatus by the communication means and by wireless.

As described above, according to this embodiment 1, since the distant view image which has been previously subjected to the rendering processing is stored as the distant view data in the external storage device 3, the rendering processing at the time when the distant view image is drawn is not required, and the distant view image has only to be retrieved and read out from the distant view data 33. Thus, there is an effect that the virtual space image display method/apparatus, the virtual space image display program and the recording medium can be provided in which an increase in the load of the apparatus including the CPU can be avoided as compared with the case where the rendering processing is performed each time the position of the point of interest, the sight line direction or the traveling direction is changed and the distant view image is drawn.

Besides, since the distant view image seen in the east, west, south, or north from the inside of each division area is created for each division area according to the distance between the position of the division area and the object, such as the high building 102, the Tokyo Tower 103, or the Mount Fuji 104, and in accordance with the change in the distant view actually seen when the point of interest is moved, there is an effect that the virtual space image display method/apparatus, the virtual space image display program and the recording medium can be provided in which the map image which is based on the perspective drawing method and in which the realistic distant view image is drawn on the background can be drawn without enhancing the processing speed.

### Embodiment 2

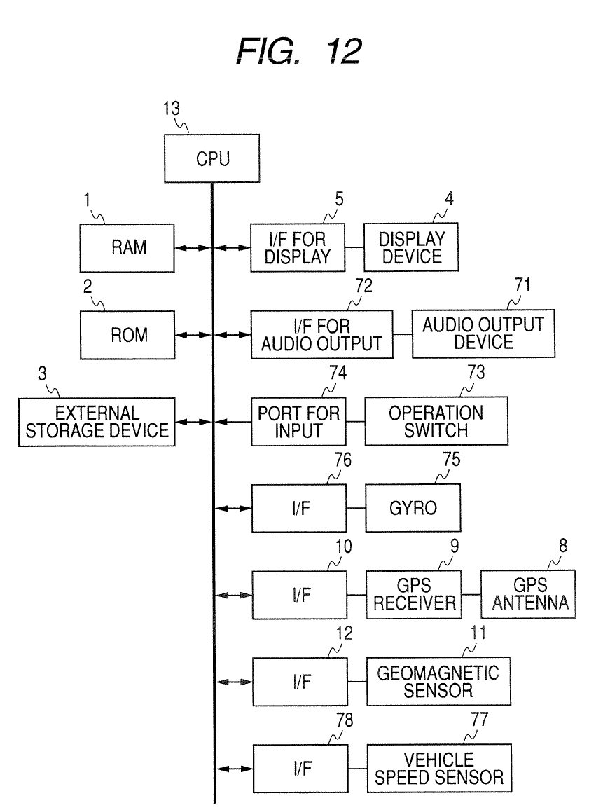

FIG. 12 is a block diagram showing a structure of an in-vehicle navigation apparatus to which the virtual space image display method/apparatus, or the virtual space image display program described in the embodiment 1 is applied. In FIG. 12, portions having the same or like functions to those of FIG. 1 are denoted by the same reference numerals.

The in-vehicle navigation apparatus includes a RAM 1, a ROM 2, and an external storage device 3 that previously stores three-dimensional map data including information indicating the positions and forms of constructions, such as roads and buildings, of map data divided into specified division areas, and distant view data which are distant view images for the respective division areas and are previously subjected to the rendering processing.

Besides, the in-vehicle navigation apparatus includes a display device 4, an interface 5 for display through which a CPU 13 transmits/receives various signals for displaying map images based on a perspective drawing method on the display device 4 to/from the display device 4, an audio output device 71 for performing various guides including a road guide not only through a screen of the display device 4 but also through an effective sound or voice, and an interface 72 for audio output through which the CPU 13 transmits/receives signals, by which the audio output device 71 performs the various guides through the effective sound or voice, to/from the audio output device 71.

Further, there are provided an operation switch 73 for variously operating the in-vehicle navigation apparatus, and an input port 74 for inputting the operation through the operation switch 73 to the in-vehicle navigation apparatus as an electric signal.

Besides, the in-vehicle navigation apparatus includes a GPS receiver 9 provided with a GPS antenna 8, an interface 10 through which the CPU 13 transmits/receives various signals to/from the GPS receiver 9, a geomagnetic sensor 11 that detects the terrestrial magnetism and outputs an orientation signal with a specified resolution for fixing the orientation of a sight line direction or a traveling direction, and an interface 12 through which the CPU 13 transmits/receives various signals including the orientation signal outputted from the geomagnetic sensor 11 to/from the geomagnetic sensor 11.

Besides, the in-vehicle navigation apparatus includes a gyro 75 for determining the traveling direction, an interface 76 through which the CPU 13 transmits/receives various signals including the output signal of the gyro 75 to/from the gyro 75, a vehicle speed sensor 77 for detecting a vehicle speed, and an interface 78 through which the CPU 13 transmits/receives various signals including the output signal of the vehicle speed sensor 77 to/from the vehicle speed sensor 77.

In this in-vehicle navigation apparatus, various guides are performed through the map image which is based on the perspective drawing method and is drawn by the virtual space image display method described in the embodiment 1.

Besides, in this in-vehicle navigation apparatus, the point-of-interest acquisition means 21 of FIG. 2 realizes a function to acquire information of the point of interest as the present position of the vehicle and the traveling direction based on various information, such as the latitude and longitude information detected based on the GPS signal received by the GPS receiver 9 from the GPS satellite, a vehicle speed pulse as the output signal of the vehicle speed sensor 77, the output signal of the gyro 75, and the orientation obtained from the output of the geomagnetic sensor 11, and to determine the division area where the point of interest is included.

Accordingly, in the in-vehicle navigation apparatus of the embodiment 2, since the distant view image can be drawn by merely retrieving and reading the distant view data which is stored in the external storage device 3 and has been previously subjected to the rendering processing, there is an effect that the in-vehicle navigation apparatus can be provided in which an increase in the load of the apparatus including the CPU for drawing the distant view image can be avoided as compared with the case where the rendering processing is performed each time the present position of the vehicle or the traveling direction of the vehicle is changed and the distant view image is drawn.

Besides, since the distant view image seen in the east, west, south, or north from the inside of each division area is created for each division area according to the distance between the position of the division area and the distant view image drawing object and in accordance with the change in the distant view actually seen when the vehicle is moved, there is an effect that the in-vehicle navigation apparatus can be provided in which the map image which is based on the perspective drawing method and in which the realistic distant view image is drawn on the background can be drawn without enhancing the processing speed.

### Embodiment 3

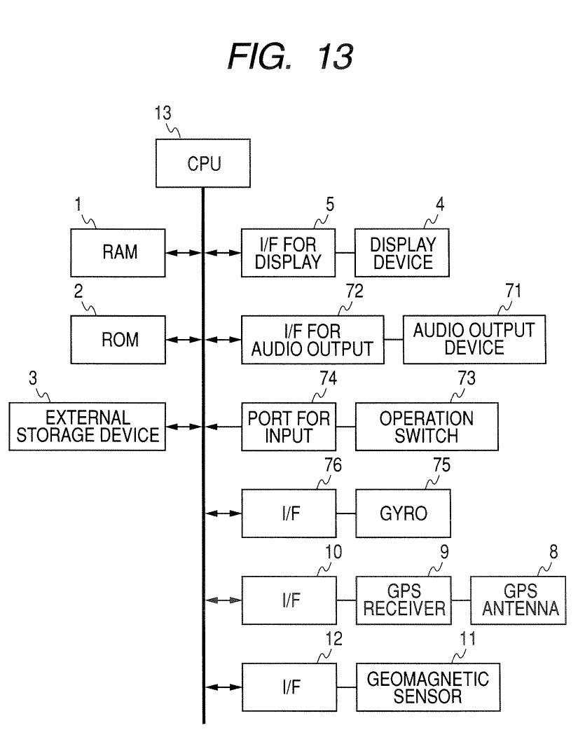

FIG. 13 is a block diagram showing a structure of a portable navigation apparatus to which the virtual space image display method/apparatus, or the virtual space image display program described in the embodiment 1 is applied. In FIG. 13, portions having the same or like functions to those of FIG. 12 are denoted by the same reference numerals and their description will be omitted.

Since the portable navigation apparatus of the embodiment 3 is used while the user carries it, the vehicle sensor 77 is not provided unlike the in-vehicle navigation apparatus.

In this portable navigation apparatus, the point-of-interest acquisition means 21 of FIG. 2 realizes a function to acquire information of the point of interest as the present position and the sight line direction or traveling direction based on various information, such as latitude and longitude information detected based on a GPS signal received by a GPS receiver 9 from a GPS satellite, an output signal of a gyro 75, and an orientation obtained from the output of a geomagnetic sensor 11, and to determine the division area where the point of interest is included.

Accordingly, in the portable navigation apparatus of the embodiment 3, since the distant view image can be drawn by merely retrieving and reading the distant view data which is stored in an external storage device 3 and has been subjected to the rendering processing, there is an effect that the portable navigation apparatus can be provided in which an increase in the load of the apparatus including the CPU for drawing the distant view image can be avoided as compared with the case where the rendering processing is performed each time the present position, the sight line direction or the traveling direction is changed and the distant view image is drawn.

Besides, since the distant view image seen in the east, west, south, or north from the inside of each division area is created for each division area according to the distance between the position of the division area and the distant view image drawing object and in accordance with the change in the distant view actually seen when the vehicle is moved, there is an effect that the portable navigation apparatus can be provided in which the map image which is based on the perspective drawing method and in which the realistic distant view image is drawn on the background can be drawn without enhancing the processing speed.

It should be understood by those skilled in the art that various modifications, combinations, sub-combinations and alterations may occur depending on design requirements and other factors insofar as they are within the scope of the appended claims or the equivalents thereof.

What is claimed is:

1. A virtual space image display method in which when viewing is made in an arbitrary direction from a point of interest on map data, a drawing object on the map data positioned in the direction is drawn and displayed on the basis of three-dimensional map data of the drawing object as a map image based on a perspective drawing method, the virtual space image display method comprising the steps of:
holding three-dimensional map data of drawing objects in respective division areas, which are obtained by dividing the map data into specified areas, in a recording medium for the respective division areas;
holding distant view images of drawing objects for a distant view in respective directions on the map data, which are obtained when surroundings are viewed from an inside of the division area, in the recording medium while the distant view images are made to correspond to the division area and the directions;
acquiring, by point-of-interest acquisition means, position information of the point of interest and sight line direction information concerning a sight line direction or a traveling direction at the point of interest;
retrieving, by neighboring map data retrieval means, three-dimensional map data of a drawing object for a near view positioned in the sight line direction or the traveling direction, including a drawing object in the division area where the point of interest exists, from the three-dimensional map data held in the recording medium on the basis of the acquired position information of the point of interest and the sight line direction information;
performing, by real-time rendering means, a rendering processing on the retrieved three-dimensional map data to convert the drawing object for the near view positioned in the sight line direction or the traveling direction into a map image based on the perspective drawing method;
retrieving, by distant view data retrieval means, a distant view image obtained when viewing is made in the sight line direction or the traveling direction from the inside of the division area where the point of interest exists, from the distant view images held in the recording medium on the basis of the acquired position information of the point of interest and the sight line direction information; and
overwriting, by combining means, the retrieved distant view image with the drawing object for the near view converted into the map image based on the perspective drawing method to combine them, and drawing and displaying them as a map image based on the perspective drawing method in the sight line direction or the traveling direction at the point of interest.

2. The virtual space image display method according to claim 1, wherein with respect to the distant view images of the drawing objects for the distant view held in the recording medium for the respective division areas, the distant view images of the drawing objects for the distant view in the respective directions on the map data, which are obtained when the surroundings are seen from the inside of the division area and have sizes corresponding to distances between the division area and the drawing objects for the distant view, are held in the recording medium for the respective division areas.

3. The virtual space image display method according to claim 1, wherein the division areas are rectangles obtained by dividing a map mesh of the Geographical Survey Institute.

4. The virtual space image display method according to claim 1, wherein the division areas are hexagons obtained by dividing a map mesh of the Geographical Survey Institute.

5. The virtual space image display method according to claim 1, wherein the point-of-interest acquisition means acquires the position information of the point of interest as a present position of a vehicle and the sight line direction information at the point of interest based on a GPS signal sent from a GPS satellite and received by a GPS receiver, an output signal of a vehicle speed sensor, and an output signal of a gyro.

6. The virtual space image display method according to claim 1, wherein the point-of-interest acquisition means acquires the position information of the point of interest and the sight line direction information at the point of interest based on a signal inputted when an input device is operated by a user.

7. The virtual space image display method according to claim 1, wherein the distant view images of the drawing objects for the distant view are downloaded to the recording medium from an external server system through communication means before the point of interest enters the inside of the division area.

8. The virtual space image display method according to claim 1, wherein the distant view images of the drawing objects for the distant view have been previously subjected to the rendering processing.

9. A virtual space image display apparatus in which when viewing is made in an arbitrary direction from a point of interest on map data, a drawing object on the map data positioned in the direction is drawn and displayed on the basis of three-dimensional map data of the drawing object as a map image based on a perspective drawing method, the virtual space image display apparatus comprising:
a recording medium that holds three-dimensional map data of drawing objects in respective division areas which are obtained by dividing the map data into specified areas, and distant view images of drawing objects for a distant view in respective directions on the map data, which are obtained when surroundings are viewed from an inside of the division area, for the respective division areas;
point-of-interest acquisition means for acquiring position information of the point of interest and sight line direction information concerning a sight line direction or a traveling direction at the point of interest;
neighboring map data retrieval means for retrieving three-dimensional map data of a drawing object for a near view positioned in the sight line direction or the traveling direction, including a drawing object in the division area where the point of interest exists, from the three-dimensional map data held in the recording medium on the basis of the acquired position information of the point of interest and the sight line direction information;
real-time rendering means for performing a rendering processing on the retrieved three-dimensional map data to convert the drawing object for the near view positioned in the sight line direction or the traveling direction into a map image based on the perspective drawing method;
distant view data retrieval means for retrieving a distant view image obtained when viewing is made in the sight line direction or the traveling direction from the inside of the division area where the point of interest exists, from the distant view images held in the recording medium on the basis of the acquired position information of the point of interest and the sight line direction information; and
combining means for overwriting the retrieved distant view image with the drawing object for the near view converted into the map image based on the perspective drawing method to combine them, and for drawing and displaying them as a map image based on the perspective drawing method in the sight line direction or the traveling direction at the point of interest.

10. The virtual space image display apparatus according to claim 9, wherein with respect to the distant view images of the drawing objects for the distant view held in the recording medium for the respective division areas, the distant view images of the drawing objects for the distant view in the respective directions on the map data, which are obtained when the surroundings are seen from the inside of the division area and have sizes corresponding to distances between the division area and the drawing objects for the distant view, are held in the recording medium for the respective division areas.

11. The virtual space image display apparatus according to claim 9, further comprising:
a GPS receiver,
a vehicle speed sensor, and
a gyro,
wherein the point-of-interest acquisition means acquires the position information of the point of interest as a present position of a vehicle and the sight line direction information at the point of interest based on a GPS signal sent from a GPS satellite and received by the GPS receiver, an output signal of the vehicle speed sensor, and an output signal of the gyro.

12. The virtual space image display apparatus according to claim 9, further comprising an input device including a keyboard, a mouse or an operation pad,
wherein the point-of-interest acquisition means acquires the position information of the point of interest and the sight line direction information at the point of interest based on a signal inputted when the input device is operated by a user.

13. The virtual space image display apparatus according to claim 9, further comprising communication means for receiving the distant view images of the drawing objects for the distant view from an external server system,
wherein the communication means downloads the distant view images of the drawing objects for the distant view to the recording medium from the external server system before the point of interest enters the inside of the division area.

14. The virtual space image display apparatus according to claim 9, wherein the distant view images of the drawing objects for the distant view have been previously subjected to the rendering processing.

15. A computer readable recording medium recording a virtual space image display program in which when viewing is made in an arbitrary direction from a point of interest on map data, a drawing object on the map data positioned in the direction is drawn and displayed on the basis of three-dimensional map data of the drawing object as a map image based on a perspective drawing method, the computer-readable recording medium recording the virtual space image display program for causing a computer to execute the processes of:
holding three-dimensional map data of drawing objects in respective division areas, which are obtained by dividing the map data into specified areas, in a recording medium for the respective division areas;
holding distant view images of drawing objects for a distant view in respective directions on the map data, which are obtained when surroundings are viewed from an inside of the division area, in the recording medium while the distant view images are made to correspond to the division area and the directions;
acquiring, by point-of-interest acquisition means, position information of the point of interest and sight line direction information concerning a sight line direction or a traveling direction at the point of interest;
retrieving, by neighboring map data retrieval means, three-dimensional map data of a drawing object for a near view positioned in the sight line direction or the traveling direction, including a drawing object in the division area where the point of interest exists, from the three-dimensional map data held in the recording medium on the basis of the acquired position information of the point of interest and the sight line direction information;
performing, by real-time rendering means, a rendering processing on the retrieved three-dimensional map data to convert the drawing object for the near view positioned in the sight line direction or the traveling direction into a map image based on the perspective drawing method;
retrieving, by distant view data retrieval means, a distant view image obtained when viewing is made in the sight line direction or the traveling direction from the inside of the division area where the point of interest exists, from the distant view images held in the recording medium on the basis of the acquired position information of the point of interest and the sight line direction information; and
overwriting, by combining means, the retrieved distant view image with the drawing object for the near view converted into the map image based on the perspective drawing method to combine them, and drawing and displaying them as a map image based on the perspective drawing method in the sight line direction or the traveling direction at the point of interest.

16. The recording medium according to claim 15, wherein with respect to the distant view images of the drawing objects for the distant view held in the recording medium, the distant view images of the drawing objects for the distant view in the respective directions on the map data, which are obtained when the surroundings are seen from the inside of the division area and have sizes corresponding to distances between the division area and the drawing objects for the distant view, are held in the recording medium for the respective division areas and the respective directions.

17. A virtual space image display apparatus in which when viewing is made in an arbitrary direction from a point of interest on map data, a drawing object on the map data positioned in the direction is drawn and displayed on the basis of three-dimensional map data of the drawing object as a map image based on a perspective drawing method, the virtual space image display apparatus comprising:
a recording medium that holds three-dimensional map data of drawing objects in respective division areas which are obtained by dividing the map data into specified areas, and distant view images of drawing objects for a distant view in respective directions on the map data, which are obtained when surroundings are viewed from an inside of the division area, for the respective division areas;
a point-of-interest acquisition unit configured to acquire position information of the point of interest and sight line direction information concerning a sight line direction or a traveling direction at the point of interest;
a neighboring map data retrieval unit configured to retrieve three-dimensional map data of a drawing object for a near view positioned in the sight line direction or the traveling direction, including a drawing object in the division area where the point of interest exists, from the three-dimensional map data held in the recording medium on the basis of the acquired position information of the point of interest and the sight line direction information;
a real-time rendering unit configured to perform a rendering processing on the retrieved three-dimensional map data to convert the drawing object for the near view positioned in the sight line direction or the traveling direction into a map image based on the perspective drawing method;
a distant view data retrieval unit configured to retrieve a distant view image obtained when viewing is made in the sight line direction or the traveling direction from the inside of the division area where the point of interest exists, from the distant view images held in the recording medium on the basis of the acquired position information of the point of interest and the sight line direction information; and
a combining unit configured to overwrite the retrieved distant view image with the drawing object for the near view converted into the map image based on the perspective drawing method to combine them, and to draw and display them as a map image based on the perspective drawing method in the sight line direction or the traveling direction at the point of interest.
